(19) United States
(12) Patent Application Publication
(10) Pub. No.: US 2024/0019312 A1
(43) Pub. Date: Jan. 18, 2024

(54) TEMPERATURE SENSOR

(71) Applicants: Yazaki Corporation, Tokyo (JP); DENSO CORPORATION, Kariya-city (JP)

(72) Inventors: Tomohiro MATSUSHIMA, Shizuoka (JP); Tsuyoshi TANAKA, Anjo-city (JP); Nakae YUZAWA, Anjo-city (JP)

(73) Assignees: Yazaki Corporation, Tokyo (JP); DENSO CORPORATION, Kariya-city (JP)

(21) Appl. No.: 18/350,108

(22) Filed: Jul. 11, 2023

(30) Foreign Application Priority Data
Jul. 14, 2022 (JP) 2022-112988

(51) Int. Cl. G01K 1/14

(52) U.S. Cl. CPC G01K 1/14

(57) ABSTRACT

A temperature sensor including a sensor part and a biasing member that is capable of pressing the sensor part. Here, the biasing member includes a pressing part, a biasing part, and a part to be held. The part to be held includes a locking piece that is elastically deformable in an intersecting direction intersecting with the pressing direction, and hooks that are locked by the holding member in a state where movement of the hooks to the other side in the pressing direction is regulated. The biasing member includes a regulating part that regulates movement of the locking piece in the intersecting direction and prevents release of locking between the hooks and the holding member.

### CROSS REFERENCE TO RELATED APPLICATION

The present application is based on, and claims priority from the prior Japanese Patent Application No. 2022-112988, filed on Jul. 14, 2022, the entire contents of which are incorporated herein by reference.

### TECHNICAL FIELD

The present disclosure relates to a temperature sensor.

### BACKGROUND

Japanese Unexamined Patent Application Publication No. 2020-012809 proposes a temperature sensor including a biasing member capable of pressing a sensor part. In this Japanese Unexamined Patent Application Publication No. 2020-012809, the biasing member includes a pressing part that presses the sensor part toward a part to be measured, a biasing part that presses the pressing part toward the part to be measured (lower side), and a cover that is held by a holding member.

In addition, in Japanese Unexamined Patent Application Publication No. 2020-012809, the cover includes locking pieces that are elastically deformable in the horizontal direction, and locking parts that are provided on the locking pieces and are locked by the holding member while movement toward the other side (upper side in the up-down direction) in the pressing direction is regulated. This causes the movement of the locking parts toward the side (upper side) opposite to the side where the part to be measured is placed to be regulated, which enables the temperature sensor to be more reliably brought into contact with the part to be measured. Configuring the temperature sensor as described above makes it possible to prevent degradation in the temperature measurement performance by the temperature sensor with respect to the part to be measured.

### SUMMARY

Even with the above-described configuration disclosed in Japanese Unexamined Patent Application Publication No. 2020-012809, it is possible to prevent the degradation of the temperature measurement performance for the part to be measured. However, it is preferable to make it possible to more reliably prevent the degradation of the temperature measurement performance of the part to be measured.

An object of the present disclosure is to provide a temperature sensor capable of more reliably preventing the degradation of the temperature measurement performance of the part to be measured.

A temperature sensor according to an embodiment includes a sensor part that is provided on a flexible thin-plate wire and detects a temperature of a part to be measured, and a biasing member that is capable of pressing the sensor part, wherein the biasing member includes a pressing part that presses the sensor part toward the part to be measured, a biasing part that applies to the pressing part a biasing force toward one side in a pressing direction in which the sensor part is pressed toward the part to be measured, and a part to be held that is to be held by a holding member in a state where movement of the part to be held to the other side in the pressing direction is regulated, the part to be held includes a locking piece that is elastically deformable in an intersecting direction intersecting with the pressing direction, and a locking part that is provided on the locking piece and is to be locked by the holding member in a state where movement of the locking part to the other side in the pressing direction is regulated, and the biasing member includes a regulating part that regulates movement of the locking piece in the intersecting direction and prevents release of locking between the locking part and the holding member.

### BRIEF DESCRIPTION OF THE DRAWINGS

FIG. 1 is a plan view illustrating an example place where a temperature sensor according to an embodiment is placed.

FIG. 2 is a perspective view illustrating a mounting structure of a temperature sensor according to a first embodiment.

FIG. 3 is an exploded perspective view illustrating a biasing member provided in the temperature sensor according to the first embodiment.

FIG. 4 is a diagram illustrating the mounting structure of the temperature sensor according to the first embodiment and is a cross-sectional view of the temperature sensor cut in a plane perpendicular to the width direction when held by a holding member while not in contact with a part to be measured.

FIG. 5 is a diagram illustrating the mounting structure of the temperature sensor according to the first embodiment, and is a cross-sectional view of the temperature sensor cut in a plane perpendicular to the front-rear direction when held by the holding member while not in contact with the part to be measured.

FIG. 6 is a diagram illustrating the mounting structure of the temperature sensor according to the first embodiment, and is a cross-sectional view of the temperature sensor cut in a plane perpendicular to the front-rear direction when held by the holding member while in contact with the part to be measured.

FIG. 7 is a diagram illustrating the mounting structure of the temperature sensor according to the first embodiment, and is a cross-sectional view of the temperature sensor cut in a plane perpendicular to the front-rear direction when held by the holding member while in contact with the part to be measured and when a pressing part is moved upward.

FIG. 8 is a diagram illustrating a mounting structure of a temperature sensor according to a modified example of the first embodiment, and is a cross-sectional view of the temperature sensor cut in a plane perpendicular to the front-rear direction when held by the holding member while in contact with the part to be measured.

FIG. 9 is a diagram illustrating the mounting structure of the temperature sensor according to the modified example of the first embodiment, and is a cross-sectional view of the temperature sensor cut in a plane perpendicular to the front-rear direction when held by the holding member while in contact with the part to be measured and when the pressing part is moved upward.

FIG. 10 is a cross-sectional view of a mounting structure of a temperature sensor according to a second embodiment cut in a plane perpendicular to the front-rear direction.

FIG. 11 is a cross-sectional view of a mounting structure of a temperature sensor according to a third embodiment cut in a plane perpendicular to the front-rear direction.

FIG. 12 is a cross-sectional view of a main part of a mounting structure of a temperature sensor according to a fourth embodiment cut in a plane perpendicular to the front-rear direction.

FIG. 13 is a cross-sectional view of a mounting structure of a temperature sensor according to a fifth embodiment cut in a plane perpendicular to the front-rear direction.

FIG. 14 is a perspective view illustrating a biasing member module provided in a temperature sensor according to a sixth embodiment.

FIG. 15 is a cross-sectional view of a mounting structure of the temperature sensor according to the sixth embodiment cut in a plane perpendicular to the front-rear direction.

FIG. 16 is a cross-sectional view of the mounting structure of the temperature sensor according to the sixth embodiment cut in a plane perpendicular to the width direction.

FIG. 17 is a perspective view illustrating a mounting structure of a temperature sensor according to a seventh embodiment.

FIG. 18 is an exploded perspective view illustrating the mounting structure of the temperature sensor according to the seventh embodiment.

FIG. 19 is a cross-sectional view of the mounting structure of the temperature sensor according to the seventh embodiment cut in a plane perpendicular to the width direction.

FIG. 20 is a perspective view illustrating a mounting structure of a temperature sensor according to an eighth embodiment.

FIG. 21 is an exploded perspective view illustrating the mounting structure of the temperature sensor according to the eighth embodiment.

FIG. 22 is a plan view illustrating the mounting structure of the temperature sensor according to the eighth embodiment.

### DETAILED DESCRIPTION

Various embodiments will be described hereinafter with reference to the accompanying drawings.

A temperature sensor according to the present embodiment will be described in detail below using the drawings. The following exemplifies a temperature sensor that detects the temperature of a cell included in a battery module installed in an electrified vehicle (for example, HV, PHV, EV, FCV, and the like). Note that the dimensional ratios in the drawings are exaggerated for illustrative purposes and may differ from the actual ratios.

In the following description, an up-down direction when a cell is positioned downward and a temperature sensor is brought into contact with the cell from above is defined as the up-down direction of the temperature sensor. A direction in which a flexible thin-plate wire extends is defined as the front-rear direction of the temperature sensor and the holding member, and the width direction of the flexible thin-plate wire is defined as the width direction of the temperature sensor and the holding member. In addition, the mounting side of the flexible thin-plate wire is defined as the front in the front-rear direction.

In addition, similar components are included in the following multiple embodiments. Thus, in the following, common symbols are assigned to those similar components, and overlapping descriptions are omitted.

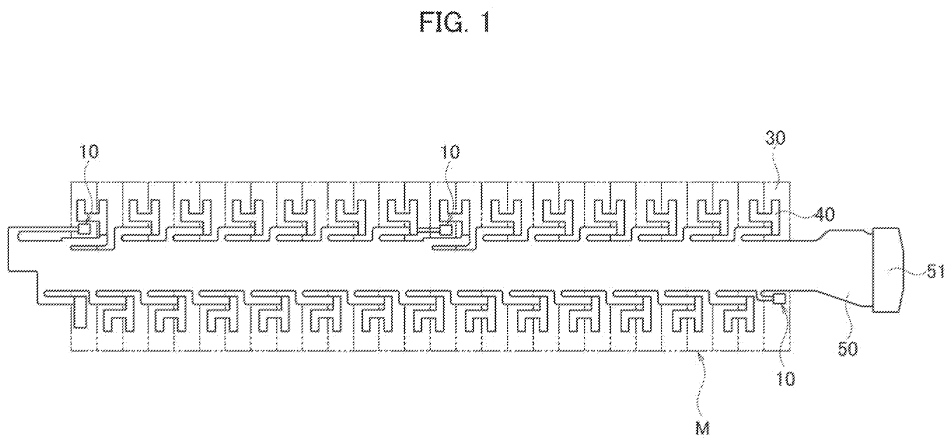

First, an example of a place where a temperature sensor 10 according to the present embodiment is placed will be described based on FIG. 1.

The temperature sensor 10 according to the present embodiment is a sensor for detecting the temperature of a cell (part to be measured) 30 that is mounted on an electrified vehicle, such as an electric vehicle or a hybrid electric vehicle, and is used as a driving source.

Specifically, multiple (28 in the present embodiment) cells 30 are arranged side by side and terminals (not illustrated) of adjacent cells 30 are connected to a bus bar 40, which forms a battery pack (battery module) M where the multiple cells are connected in series or parallel. The temperature sensor 10 is arranged to come into contact with a cell which is a part of the multiple cells 30 included in the battery pack M. In the present embodiment, three temperature sensors 10 are respectively brought into contact with three cells 30, which are a part of the multiple cells 30. Note that a lithium battery, for example, can be used as the cell 30.

In the present embodiment, three temperature sensors 10 are connected to a flexible printed circuit board (FPC) 50. Temperature data of each cell 30 detected by the three temperature sensors 10 is output to an ECU (electrical control unit) via a connector 51. Thus, in the present embodiment, using the flexible printed circuit board (FPC) 50 makes it possible to reduce the height of the busbar module connected to the battery pack (battery module) M while improving the degree of freedom in the arrangement of electronic components.

In addition, the temperature sensor 10 is in contact with the cell 30 while held in a housing (holding member 20) provided in the busbar module. That is, the temperature sensor 10 is held in the holding member 20 while the temperature sensor 10 is in contact with the cell 30, which forms a mounting structure 1 of the temperature sensor 10.

The specific configuration of the mounting structure 1 of the temperature sensor 10 will be described below.

### First Embodiment

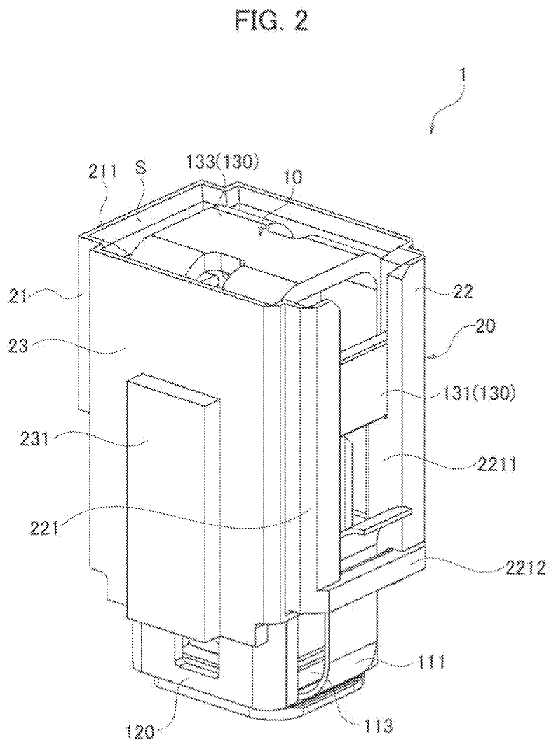

First, the mounting structure 1 of the temperature sensor 10 according to the first embodiment will be described using FIGS. 2 to 7.

The mounting structure 1 of the temperature sensor 10 according to the present embodiment is formed by the temperature sensor 10 being held by the holding member in a state where the upward movement of the temperature sensor 10 in the up-down direction is regulated.

The temperature sensor 10 includes a temperature sensor module 110, a case 120 in which the temperature sensor module 110 is inserted from above and held, and a biasing member 130 capable of pressing the temperature sensor module 110 from above.

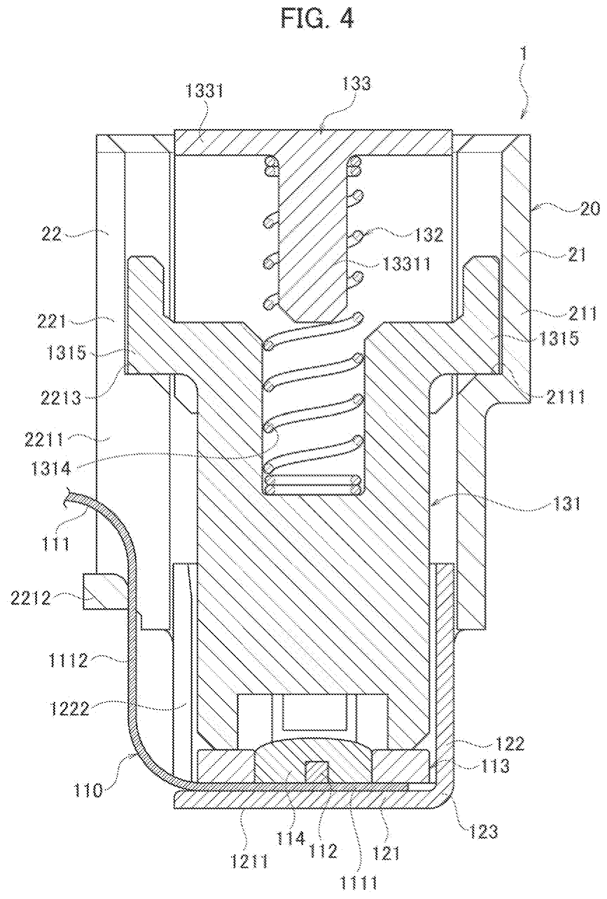

As illustrated in FIG. 4, the temperature sensor module 110 also includes a flexible thin-plate wire 111 and a sensor chip (sensor part) 112 provided on the flexible thin-plate wire 111 to detect the temperature of the cell (part to be measured) 30. In addition, the temperature sensor module 110 includes a frame-shaped member 113 arranged around the sensor chip 112, and a resin-coated part 114 filled between the frame-shaped member 113 and the sensor chip 112 to cover the sensor chip 112 so as not to expose the sensor chip 112 to the outside.

In the present embodiment, a flexible printed circuit board (FPC) is used as the flexible thin-plate wire 111. The flexible printed circuit board (FPC) includes a mounting part 1111 that is provided at the tip thereof and on which the sensor chip 112 is mounted, and a cable 1112 that is connected to the mounting part 1111.

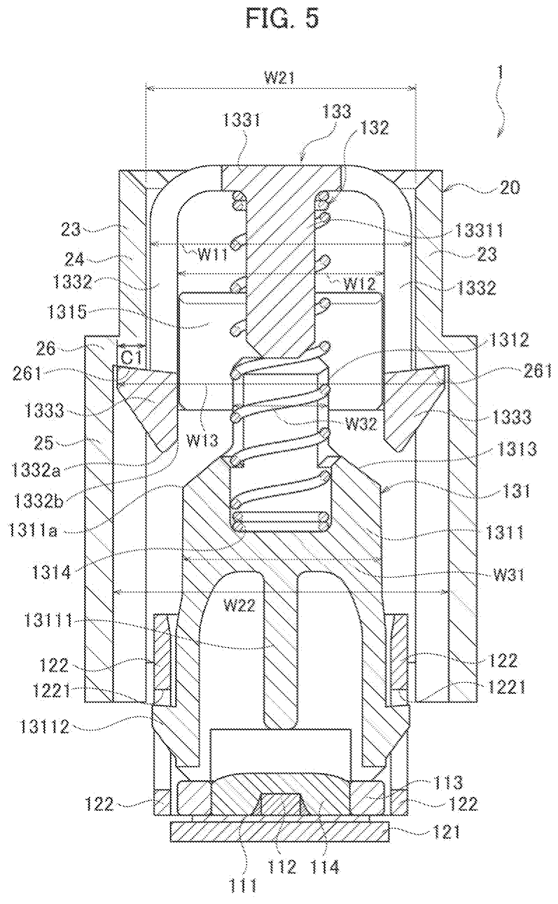

The case 120 can be formed using a material having high thermal conductivity (for example, metal, metal oxide, ceramic, and the like), and in the present embodiment, metal is used to form the case 120. As illustrated in FIGS. 4 and 5, the metal case 120 includes an approximately rectangular plate-shaped bottom wall 121 and a peripheral wall 122 connected to the bottom wall 121 through a connecting wall 123, and has an approximately rectangular parallelepiped shape opening upward.

Also, a pair of through-holes 1221 penetrating in the front-rear direction are formed in the peripheral wall 122 on both sides in the width direction, and a notch 1222 opening upward and extending in the up-down direction is formed in the peripheral wall 122 at the rear thereof in the front-rear direction. The pair of through-holes 1221 are provided to fix the pressing part 131, which is described below, of the biasing member 130 to the case 120. Meanwhile, the notch 1222 is provided to prevent the flexible thin-plate wire 111 (cable 1112) from interfering with the peripheral wall 122 when the temperature sensor module 110 is inserted into the case 120.

Furthermore, in the present embodiment, a bottom surface 1211 of the bottom wall 121 is a contact surface to be brought into contact with the cell 30. The temperature sensor module 110 is pressed downward (toward the cell 30) by the biasing member 130, and thus the bottom wall 121 of the case 120 is pressed downward (toward the cell 30). This enables the bottom surface 1211 of the bottom wall 121 to be more reliably brought into contact with the cell 30.

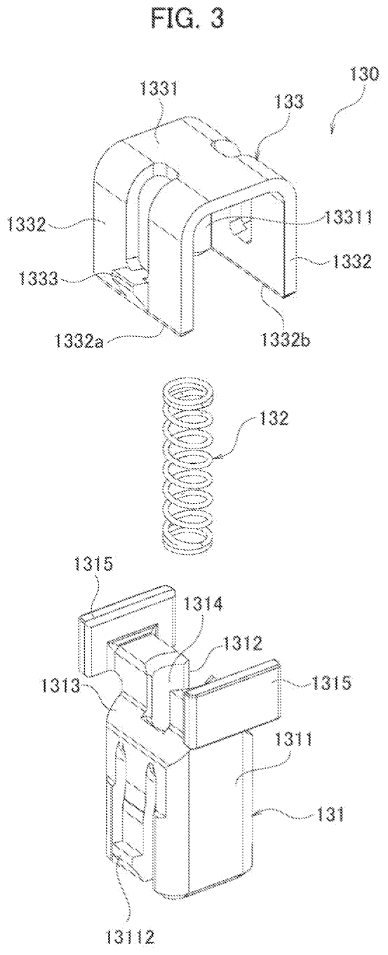

As illustrated in FIG. 3, the biasing member 130 includes the pressing part 131 that presses the temperature sensor module 110 and the case 120 toward the cell 30. In addition, the biasing member 130 includes a spring (biasing part) 132 that applies to the pressing part 131 a downward (one side in the pressing direction) biasing force for pressing the temperature sensor module 110 and the case 120 toward the cell 30. Furthermore, the biasing member 130 includes a spring presser (part to be held) 133 that is held by the holding member 20 in a state where the upward movement (the other side in the pressing direction) is regulated.

Here, in the present embodiment, the pressing part 131, the spring 132, and the spring presser 133 are formed separately. In a state where the spring 132 is interposed between the pressing part 131 and the spring presser 133, which are formed separately, the spring presser 133 is held by the holding member 20, which forms the mounting structure 1 of the temperature sensor 10.

The holding member 20 can be formed using a material, such as synthetic resin, for example, and a space S that penetrates in the up-down direction is formed therein. The temperature sensor 10 is inserted into this space S. Specifically, the holding member 20 includes a front wall 21 and a rear wall 22 that extend in the up-down direction and are opposed to each other in the front-rear direction, and a pair of side walls 23 connected to both sides of the front wall 21 and the rear wall 22 in the width direction.

In the present embodiment, as illustrated in FIG. 2, a projecting wall part 211 projecting forward is formed on the upper part of the front wall 21 at the center in the width direction, and a placement part 2111 on which the pressing part 131 of the temperature sensor 10 is placed from above is formed on the inside lower end of the projecting wall part 211.

In addition, a projecting wall part 221 projecting backward is formed on the rear wall 22. A slit 2211 opening upward is formed in the center of the projecting wall part 221 in the width direction, and the flexible thin-plate wire 111 is inserted into this slit 2211 from the upper side. A cable-holding wall 2212 is formed at the lower end of the slit 2211, and the flexible thin-plate wire 111 is held in a flexed state by this cable-holding wall 2212.

Furthermore, in the present embodiment, a placement part 2213 on which the pressing part 131 of the temperature sensor 10 is placed from above is formed in the projecting wall part 221. Thus, in the present embodiment, the pressing part 131 inserted from above into the space S is held by the placement part 2111 of the front wall 21 and the placement part 2213 of the rear wall 22 in the holding member 20.

In the present embodiment, projecting wall parts 231 projecting outward in the width direction are formed on the upper parts of the pair of side walls 23 at the center in the front-rear direction. That is, the holding member 20 includes a narrow part 24 formed on the upper part and having a relatively narrow width in the width direction, and a wide part 25 formed below the narrow part 24 and having a width wider in the width direction than that of the narrow part 24. Furthermore, in the present embodiment, the holding member 20 includes a step part 26 connecting the lower end of the narrow part 24 and the upper end of the wide part 25, and this step part 26 serves as a lock-receiving part 261 by which the spring presser 133 of the temperature sensor 10 is locked.

The pressing part 131 includes a wide part 1311 formed in the lower part and having a relatively wider width in the width direction, and a narrow part 1312 formed above the wide part 1311 and having a width narrower in the width direction than that of the wide part 1311. Furthermore, the pressing part 131 includes a connecting sloping part 1313 connecting the upper end of the wide part 1311 and the lower end of the narrow part 1312.

At the center of the wide part 1311, a pressing piece 13111 is formed that extends downward and presses the temperature sensor module 110 and the case 120 toward the cell 30. On both sides of the wide part 1311 in the width direction, locking parts 13112 that are locked by the through holes 1221 of the case 120 are formed.

Furthermore, in the present embodiment, an insertion hole 1314 in which the spring 132 is inserted and held is formed in the center of the upper end of the narrow part 1312. Also, placement walls 1315 are formed on both sides of the upper end of the narrow part 1312 in the front-rear direction to be placed on the placement part 2111 of the front wall 21 and the placement part 2213 of the rear wall 22, respectively.

With the temperature sensor module 110 and the case 120 being held, the pressing part 131 is inserted into the space S from above and the placement walls 1315 are placed on the placement part 2111 and the placement part 2213, which causes the pressing part 131 to be held by the holding member 20.

Meanwhile, the spring presser 133 includes a top wall 1331 and a pair of locking pieces 1332 that are provided to extend downward from both ends of the top wall 1331 in the width direction and are elastically deformable in the width direction (intersecting direction). In the center of the top wall 1331, a holding shaft part 13311 is formed to extend downward. Each of the pair of locking pieces 1332 is formed with a hook (locking part) 1333 that projects outward and is to be locked by the lock-receiving part 261. As described above, in the present embodiment, the spring presser 133 is held by the holding member 20 through the snap-fit.

The spring presser 133 is held by the holding member 20 using the following method. First, the spring 132 is inserted into the insertion hole 1314 of the pressing part 131 held by the holding member 20. Next, the spring presser 133 is inserted into the space S from above, and the hooks 1333 are locked by the lock-receiving parts 261 with the holding shaft part 13311 inserted into the spring 132. In this way, the spring presser 133 is held by the holding member 20.

In the present embodiment, the holding member 20 and the temperature sensor are configured as described above, and components are assembled in order from the top, which form the mounting structure 1 of the temperature sensor 10 (see FIGS. 4 and 5).

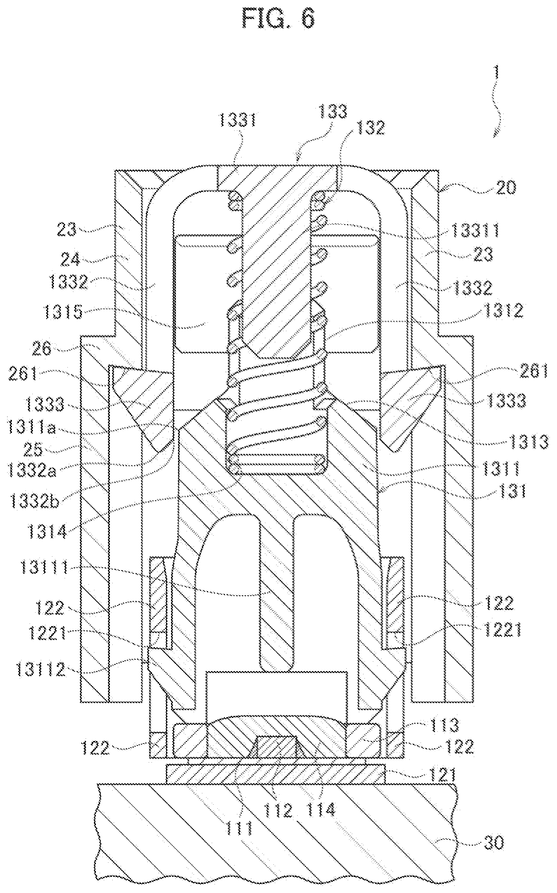

After the mounting structure 1 of the temperature sensor 10 is formed, the bottom surface 1211 of the case 120 of the temperature sensor 10 is brought into contact with the cell 30, so that the sensor chip 112 detects the temperature of the cell 30. At this time, as illustrated in FIG. 6, the bottom surface 1211 of the case 120 is brought into contact with the cell 30 with the spring 132 compressed. In this way, the temperature sensor module 110 is pressed downward by the pressing part 131 that is biased downward by the elastic restoring force of the spring 132, which enables the temperature of the cell 30 to be detected more accurately.

Here, in the present embodiment, it is possible to more reliably prevent release of the locking between the hooks 1333 and the holding member 20.

This is because, like the temperature sensor in the related art literature, a configuration in which an engagement part is provided on an engagement piece that is elastically deformable in the intersecting direction that intersects the pressing direction may have the following issues.

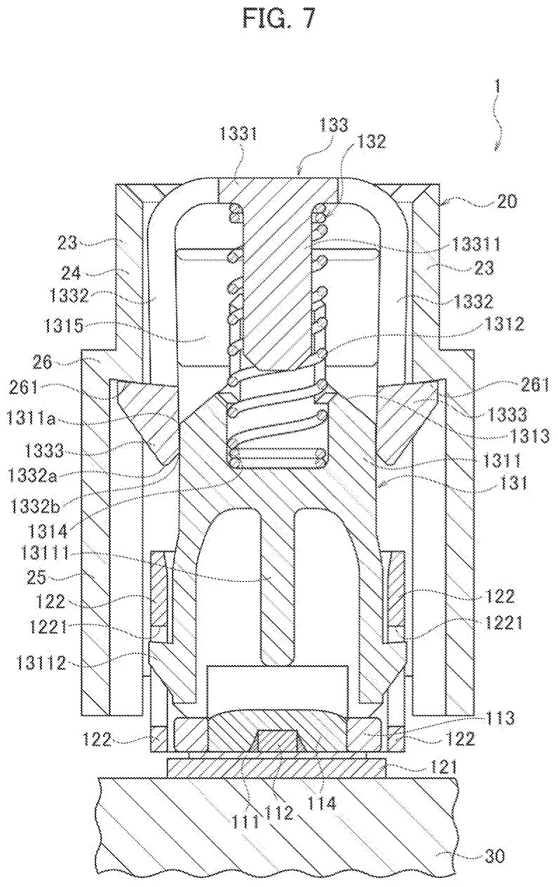

For example, if the cell 30 is mounted on a foreign object or is vibrated to be moved to the other side in the pressing direction and a large load is applied to the biasing member 130, as illustrated in FIG. 7, the engagement pieces 1332 will elastically deform and the lower ends thereof will move inward in the width direction. If the lower ends of the engagement pieces 1332 move inward in the width direction, the locking between the hooks 1333 and the lock-receiving parts 261 will become loose and the spring presser 133 may come off the holding member 20.

Thus, in the present embodiment, even when a large load is applied to the biasing member 130, it is possible to prevent release of the locking between the hooks 1333 and the lock-receiving parts 261.

Specifically, the biasing member 130 includes a regulating part that regulates the movement of the engaging pieces 1332 in the width direction and prevents release of the locking between the hooks 1333 and the lock-receiving parts 261.

Here, in the present embodiment, the regulating part is provided in the pressing part 131 and includes a pressing part-side regulating wall with which the locking pieces 1332 can be brought into contact before the locking between the hooks 1333 and the lock-receiving parts 261 is released.

Specifically, the wide part 1311 of the pressing part 131 functions as the pressing part-side regulating wall.

In the present embodiment, an inner dimension W21 of the narrow part 24 of the holding member 20 in the width direction is larger than an outer dimension W11 between the pair of locking pieces 1332 of the spring presser 133 in the width direction. In this way, it is possible to insert the pair of locking pieces 1332 into the space S of the holding member 20.

In addition, an inner dimension W12 between the pair of locking pieces 1332 of the spring presser 133 in the width direction is larger than a width W31 of the wide part 1311 of the pressing part 131. The width W31 of the wide part 1311 of the pressing part 131 is larger than a width W32 of the narrow part 1312 of the pressing part 131. In this way, it is possible for the pressing part 131 to move in the up-down direction relative to the spring presser 133 between the pair of locking pieces 1332.

In addition, an inner dimension W22 of the wide part 25 of the holding member 20 in the width direction and a width W13 between the tips of the pair of hooks 1333 of the spring presser 133 have approximately same dimensions. This makes it possible to prevent the holding member 20 from becoming larger in the width direction and to increase a locking amount Cl of the hooks 1333 and the lock-receiving parts 261.

When the mounting structure 1 of the temperature sensor 10 is formed and the temperature sensor 10 is not in contact with the cell 30, lower ends 1332a of the locking pieces 1332 of the spring presser 133 are positioned above the upper ends 1311a of the wide part 1311 of the pressing part 131. That is, in the state illustrated in FIG. 5, the locking pieces 1332 of the spring presser 133 and the wide part 1311 of the pressing part 131 do not overlap in the up-down direction. In this way, when the spring presser 133 is held by the holding member 20, it is possible to suppress the interference of the locking pieces 1332 with the wide part 1311, and it is possible for the spring presser 133 to be more reliably held by the holding member 20.

In the present embodiment, the pair of hooks 1333 are inserted into the space in the narrow part 24 of the holding member 20 when the pair of locking pieces 1332 are elastically deformed so that the lower ends 1332a bend inward in the width direction. While the pair of hooks 1333 are inserted into the space in the narrow part 24, the spring presser 133 is moved downward to position the pair of hooks 1333 in the space in the wide part 25 of the holding member 20. In this way, with the elastic restoring force of the pair of locking pieces 1332, the pair of hooks 1333 move outward in the width direction to be locked by the pair of lock-receiving parts 261, and thus the spring presser 133 is held by the holding member 20.

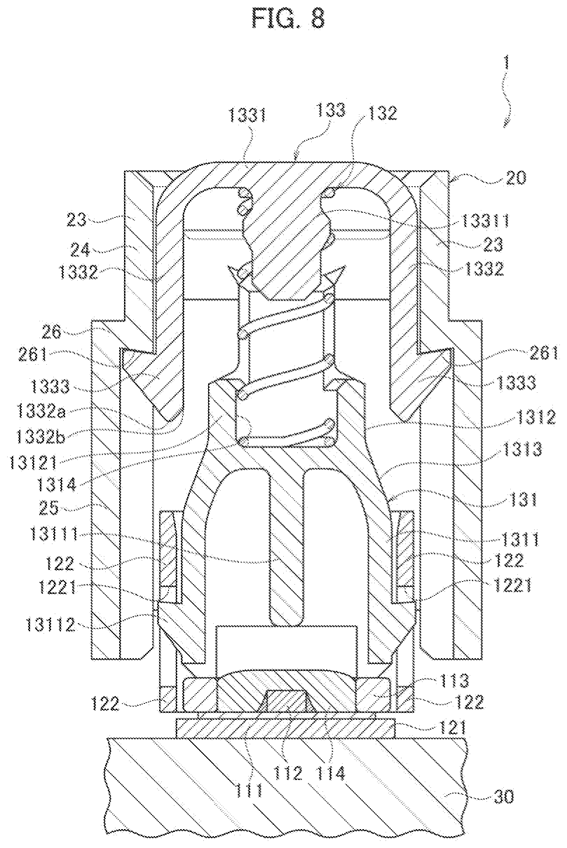

At this time, in order to insert the pair of hooks 1333 into the space within the narrow part 24, it is necessary to make the width W13 between the tips of the pair of hooks 1333 of the spring presser 133 smaller than the inner dimension W21 in the width direction of the narrow part 24 of the holding member 20. That is, until the width W13 between the tips of the pair of hooks 1333 of the spring presser 133 becomes smaller than the inner dimension W21 of the narrow part 24 of the holding member 20 in the width direction, it is necessary to bend the pair of locking pieces 1332 in such a way that the lower ends 1332a move inward in the width direction. Then, when the pair of locking pieces 1332 are bent in such a way that the lower ends 1332a move inward in the width direction, the inner sides 1332b of the lower ends 1332a of the pair of locking pieces 1332 move to the innermost side. Thus, in order to hold the spring presser 133 on the holding member 20, it is necessary to prevent the inner sides 1332b of the lower ends 1332a from contacting with the spring 132 and the narrow part 1312 while the pair of hooks 1333 are positioned in the space inside the narrow part 24. This is also true for the configuration illustrated in FIGS. 8 to 12 described below.

In contrast, when the mounting structure 1 of the temperature sensor 10 is formed and the temperature sensor 10 is in contact with the cell 30, the lower ends 1332a of the locking pieces 1332 of the spring presser 133 position below the upper ends 1311a of the wide part 1311 of the pressing part 131. That is, in the state illustrated in FIG. 6, the locking pieces 1332 of the spring presser 133 and the wide part 1311 of the pressing part 131 overlap in the up-down direction. In this way, when a large load is applied to the biasing member 130 and the pressing part 131 is moved upward relative to the spring presser 133, it is possible to prevent the pressing part 131 from being axially displaced.

Furthermore, in the present embodiment, when a large load is applied to the biasing member 130 and the pressing part 131 is moved upward relative to the spring presser 133, the locking pieces 1332, which have been moved inward in the width direction, interfere with the wide part 1311. At this time, as illustrated in FIG. 7, the locking pieces 1332 interfere with the wide part 1311 (the insides 1332b of the lower ends 1332a of the locking pieces 1332 abut on the outer surface of the wide part 1311) before the locking between the hooks 1333 and the lock-receiving parts 261 is released. That is, the width W31 of the wide part 1311 is larger than the inner dimension W12 between the pair of locking pieces 1332 in the width direction at the moment when the locking between the hooks 1333 and the lock-receiving parts 261 is released. In this way, the wide part 1311 of the pressing part 131 functions as the pressing part-side regulation wall, and it is possible to prevent release of the locking between the hooks 1333 and the lock-receiving parts 261 even when a large load is applied to the biasing member 130.

With this configuration, it becomes possible to prevent release of the locking between the hooks 1333 and the lock-receiving parts 261, while the configuration is simplified. Furthermore, even in the case where the hooks 1333 are configured to be locked by the lock-receiving parts 261 without making the hooks 1333 projecting outside the holding member 20, it becomes possible to prevent release of the locking between the hooks 1333 and the lock-receiving parts 261.

When the temperature sensor 10 is configured as described above, it becomes possible for the temperature sensor 10 to be in contact with the cell 30 until the life of the vehicle, and thus the temperature sensor 10 is prevented from floating due to vehicle vibration or the like, which enables the temperature of the cell 30 to be monitored at all times. Thus, if the temperature sensor 10 can be more reliably brought into contact with the cell 30, it becomes possible to more reliably prevent the temperature measurement performance of the cell 30 from being degraded.

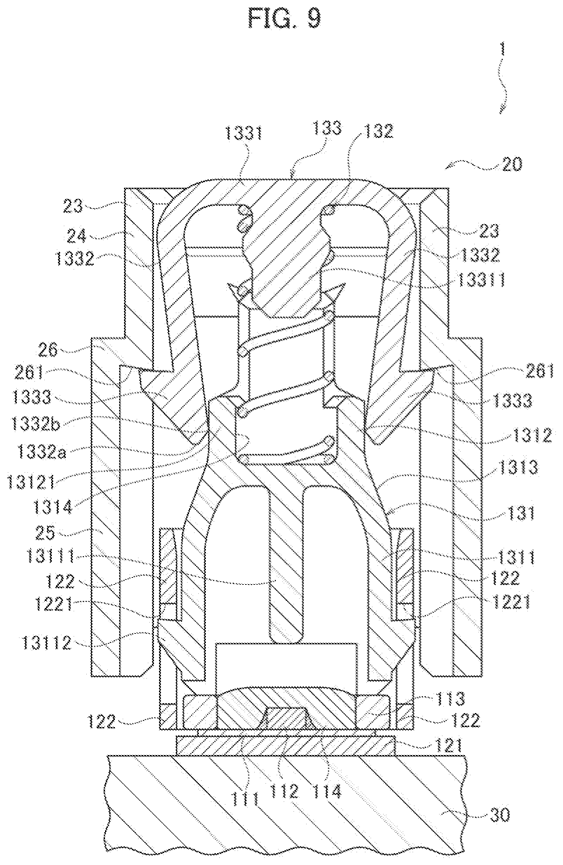

Note that as illustrated in FIGS. 8 and 9, it is also possible to make as a thick part 13121 a part of the narrow part 1312 that faces the tips (lower ends) of the locking pieces 1332 in the width direction and to make the narrow part 1312 function as the pressure part-side control wall. That is, when the locking pieces 1332 are elastically deformed inward in the width direction, it is also possible to make the locking pieces 1332 contact with the thick part 13121 before the locking between the hooks 1333 and the lock-receiving parts 261 is released.

With such a configuration, it is also possible to achieve the same actions and effects as with the temperature sensor 10 illustrated in the above-described first embodiment.

### Second Embodiment

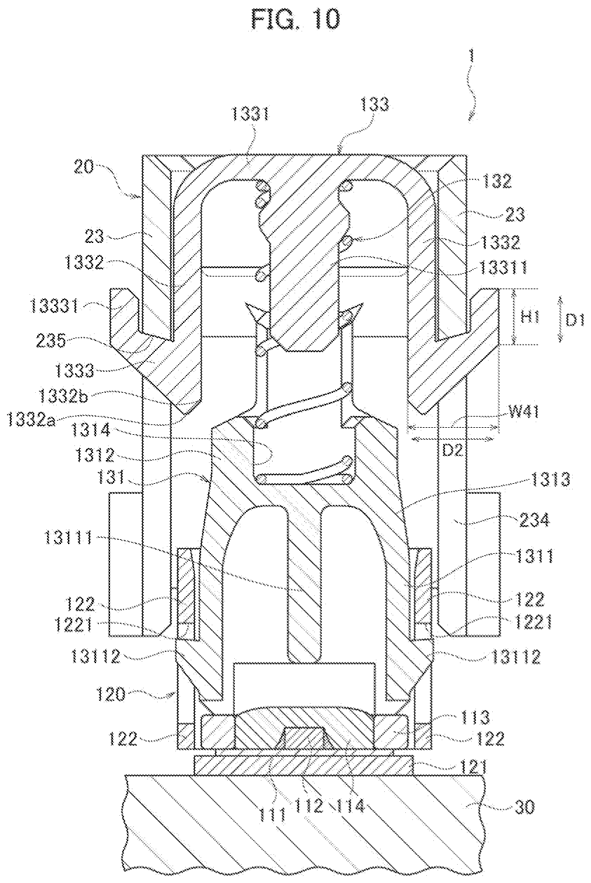

Next, the mounting structure 1 of the temperature sensor 10 according to a second embodiment will be described with reference to FIG. 10.

The mounting structure 1 of the temperature sensor 10 according to the present embodiment has basically the same structure as the mounting structure 1 of the temperature sensor 10 illustrated in the first embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

Also in the present embodiment, it is possible to more reliably prevent release of the locking between the hooks 1333 and the holding member 20.

Specifically, each of the pair of side walls 23 has a slit 234 opening downward and extending in the up-down direction formed at the center thereof in the front-rear direction, and the hooks 1333 are locked at the upper ends of the slits 234. Thus, in the present embodiment, parts of the side walls 23 where the slits 234 are formed are the lock-receiving parts 235 by which the temperature sensor 10 is locked.

The biasing member 130 includes a regulating part that regulates the movement of the locking pieces 1332 in the width direction and prevents release of the locking between the hooks 1333 and the lock-receiving parts 235.

In the present embodiment, the regulating part includes locking part-side regulating walls 13331 that are provided on the hooks 1333 and face the sidewalls 23 (holding member 20) in the width direction. Specifically, the hooks 1333 each has a folded upward shape. That is, with the hooks 1333 locked by the lock-receiving parts 235, the tips of the hooks 1333 project from the slits 234 to the outside of the side walls 23. To the parts of the hooks 1333, which project outward, the locking part-side regulating walls 13331 projecting upward are connected. In this way, when the hooks 1333 are locked by the lock-receiving parts 235, the sidewalls 23 are interposed between the locking pieces 1332 and the locking part-side regulation walls 13331.

With such a configuration, while the configuration is simplified, it is possible to prevent release of the locking between the hooks 1333 and the lock-receiving parts 235 even when a large load is applied to the biasing member 130.

Furthermore, in the present embodiment, a folded height H1 of the hooks 1333 is larger than a vibration displacement amount D1 in the up-down direction. In this way, even when a large load is applied to the biasing member 130 and the pressing part 131 moves upward relative to the spring presser 133, it is possible to prevent release of the locking between the hooks 1333 and the lock-receiving parts 235.

In addition, a folded width W 41 of the hooks 1333 is larger than a vibration displacement amount D2 in the width direction. In this way, even when the pressing part 131 moves in the width direction relative to the spring presser 133, it is possible to prevent release of the locking between the hooks 1333 and the lock-receiving parts 235.

With such a configuration, it is also possible to achieve the same actions and effects as with the temperature sensors 10 illustrated in the above-described first embodiment and its modified examples.

### Third Embodiment

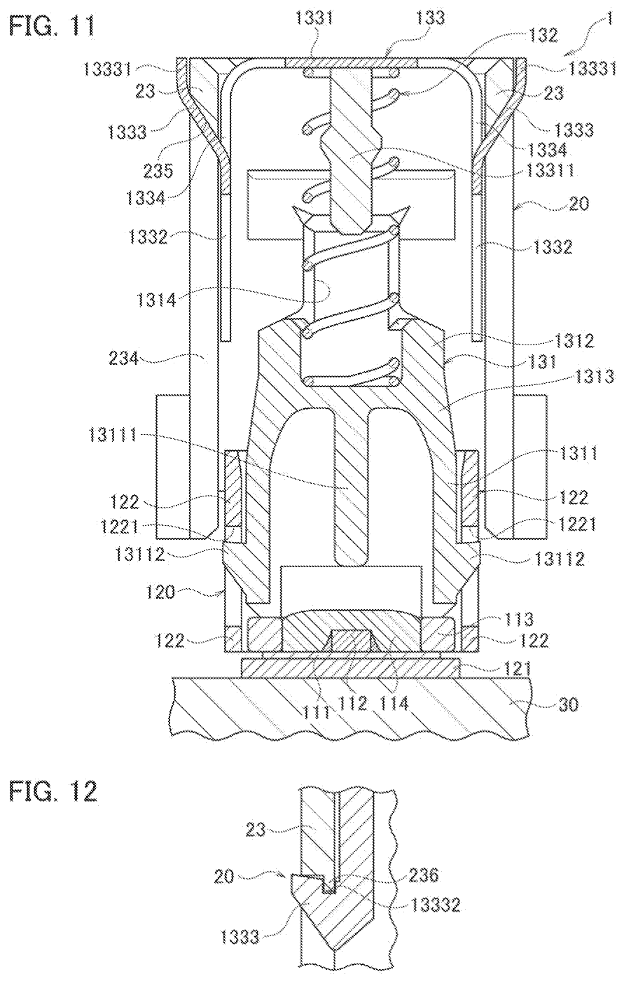

Next, the mounting structure 1 of the temperature sensor 10 according to a third embodiment will be described with reference to FIG. 11.

The mounting structure 1 of the temperature sensor 10 according to the present embodiment has basically the same structure as the mounting structure 1 of the temperature sensor 10 illustrated in the above-described second embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

In the present embodiment, it is also possible to more reliably prevent release of the locking between the hooks 1333 and the holding member 20.

Specifically, the biasing member 130 includes a regulating part that regulates the movement of the locking pieces 1332 in the width direction and prevents release of the locking between the hooks 1333 and the holding member 20. The regulating part includes locking part-side regulating walls 13331 that are provided on the hooks 1333 and face the holding member 20 in the width direction.

In the present embodiment, with the hooks 1333 locked by the holding member the tips of the hooks 1333 project from the slits 234 to the outside of the side walls 23. The locking part-side regulating walls 13331 projecting upward are connected to the parts projecting outward of the hooks 1333. In this way, when the hooks 1333 are locked by the holding member 20, the side walls 23 are interposed between the locking pieces 1332 and the locking part-side regulating walls 13331.

Here, in the present embodiment, the spring presser 133, which is a part where the locking part-side regulating walls 13331 are formed, is formed using metal. Specifically, the spring presser 133 is formed by bending one metal plate.

If the spring presser 133 is formed from metal as described above, it becomes possible to make the spring presser 133 thinner. As a result, it becomes possible to make the locking part-side regulating walls 13331 projecting outside the sidewalls 23 thinner, which enables the mounting structure 1 of the temperature sensor 10 and the temperature sensor 10 to be smaller.

Furthermore, in the present embodiment, the spring presser 133 includes sandwiching pieces 1334 with which the sidewalls 23 are sandwiched between the sandwiching pieces 1334 and the locking part-side regulating walls 13331. Thus, when the hooks 1333 are locked by the lock-receiving parts 235, the sidewalls 23 are interposed between the sandwiching pieces 1334 and the locking part-side regulating walls 13331.

With such a configuration, it is also possible to achieve the same actions and effects as with the temperature sensor 10 illustrated in the above-described first and second embodiments and its modified examples.

### Fourth Embodiment

Next, the mounting structure 1 of the temperature sensor 10 according to a fourth embodiment will be described with reference to FIG. 12.

The mounting structure 1 of the temperature sensor 10 according to the present embodiment also has basically the same structure as the mounting structure 1 of the temperature sensor 10 illustrated in the above-described second embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

In the present embodiment, it is also possible to more reliably prevent release of the locking between the hooks 1333 and the holding member 20.

Specifically, the biasing member 130 includes a regulating part that regulates the movement of the locking pieces 1332 in the width direction and prevents release of the locking between the hooks 1333 and the holding member 20.

Here, in the present embodiment, the regulating part includes regulating recess parts (regulating parts) 13332 that are provided on the hooks 1333 and into which projecting parts 236 projecting from the holding member 20 to one side in the pressing direction are inserted.

That is, when the hooks 1333 are locked by the holding member 20, the movement of the locking pieces 1332 in the width direction is regulated when the projecting parts 236 are inserted into the regulating recess parts 13332.

With such a configuration, it is also possible to achieve the same actions and effects as with the temperature sensor 10 illustrated in the above-described first to third embodiments and its modified examples.

With the configuration illustrated in the present embodiment, it is not necessary to cause the hooks 1333 to project to the outside of the holding member 20, which enables further miniaturization of the temperature sensor 10 to be achieved. Moreover, even with the configuration where the hooks 1333 are locked by the holding member 20 without making the hooks 1333 project to the outside of the holding member 20, it becomes possible to prevent release of the locking between the hooks 1333 and the holding member 20.

### Fifth Embodiment

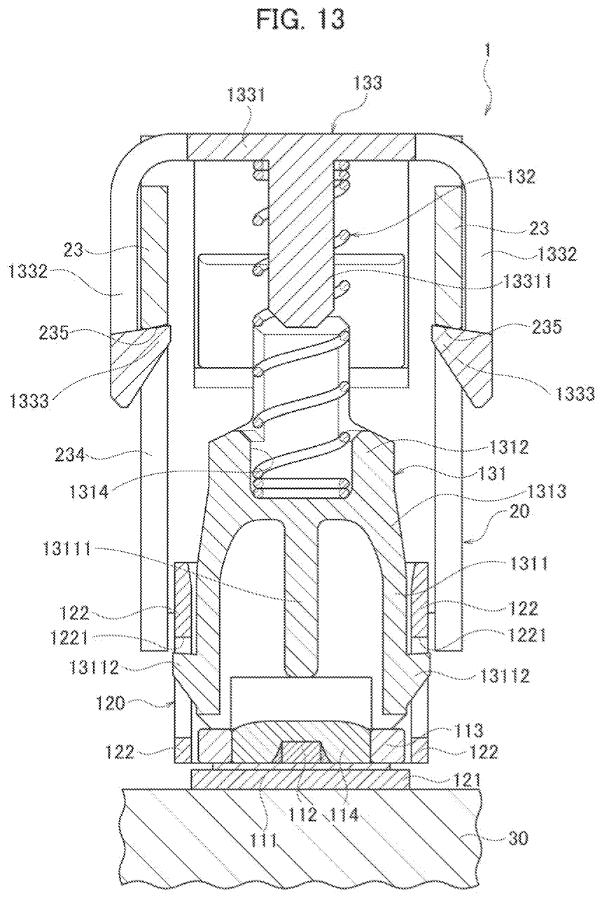

Next, the mounting structure 1 of the temperature sensor 10 according to a fifth embodiment will be described with reference to FIG. 13.

The mounting structure 1 of the temperature sensor 10 according to the present embodiment also has basically the same structure as the mounting structure 1 of the temperature sensor 10 illustrated in the above-described second embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

In the present embodiment, it is also possible to more reliably prevent release of the locking between the hooks 1333 and the holding member 20.

Specifically, the biasing member 130 includes a regulating part that regulates the movement of the locking pieces 1332 in the width direction and prevents release of the locking between the hooks 1333 and the holding member 20.

In the present embodiment, the regulating part includes the pair of locking pieces 1332, which are opposed to each other in the width direction (intersecting direction), and the hooks 1333, which are provided on the pair of locking pieces 1332 to project inward in the width direction.

Thus, in the present embodiment, the hooks 1333 are to be inserted into the slits 234 from the outside of the holding member 20.

With such a configuration, it is also possible to achieve the same actions and effects as with the temperature sensor 10 illustrated in the above-described first to fourth embodiments and its modified examples.

With the configuration illustrated in the present embodiment, it becomes possible to cause the locking pieces 1332 to be elastically deformed inward in the width direction when the cell 30 moves to the other side in the pressing direction (upper side in the up-down direction) and a large load is applied to the biasing member 130. That is, it becomes possible to cause the locking pieces 1332 to be elastically deformed in the directions to which the hooks 1333 are locked by the holding member 20. Thus, even when a large load is applied to the biasing member 130, it becomes possible to prevent release of the locking between the hooks 1333 and the holding member 20. As a result, it becomes possible to more reliably bring the temperature sensor 10 into contact with the cell 30, and thus it becomes possible to more reliably prevent the temperature measurement performance of the cell 30 from being degraded.

### Sixth Embodiment

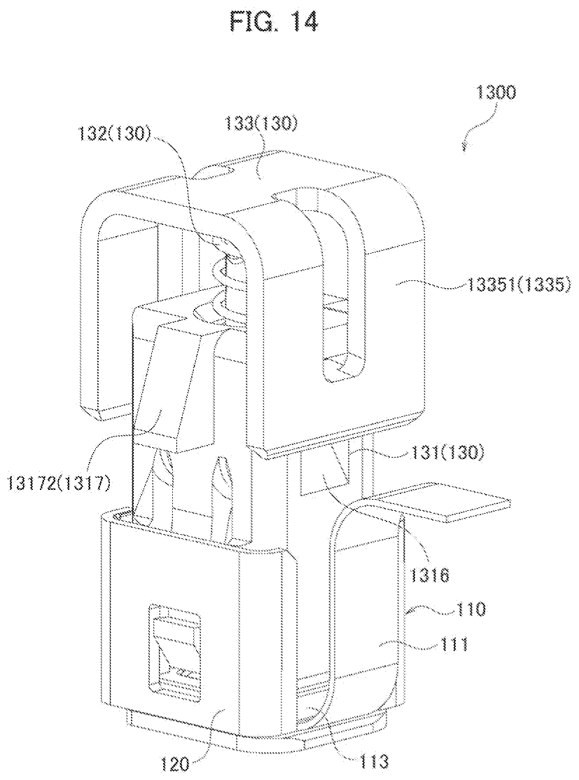

Next, the mounting structure 1 of the temperature sensor 10 according to a sixth embodiment will be described with reference to FIGS. 14 to 16.

The mounting structure 1 of the temperature sensor 10 according to the present embodiment also has basically the same structure as the mounting structure 1 of the temperature sensor 10 illustrated in the above-described second embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

The temperature sensor 10 includes the sensor chip 112 mounted on the flexible thin-plate wire 111 to detect the temperature of the cell 30, and the biasing member 130 capable of pressing the sensor chip 112.

Also, in the present embodiment, the biasing member 130 includes a biasing member module 1300, and with members made as one body, it is possible to make the temperature sensor 10 held by the holding member 20 in a state where the upward movement of the temperature sensor 10 in the up-down direction is regulated.

Specifically, the biasing member module 1300 includes the pressing part 131 that presses the sensor chip 112 toward the cell 30. The biasing member module 1300 includes a spring 132 that applies to the pressing part 131 a biasing force toward one side (the lower side in the up-down direction) in the pressing direction in which the sensor chip 112 is pressed toward the cell 30. Furthermore, the biasing member module 1300 includes the spring presser 133 that engages with the pressing part 131 while having the spring 132 positioned therebetween.

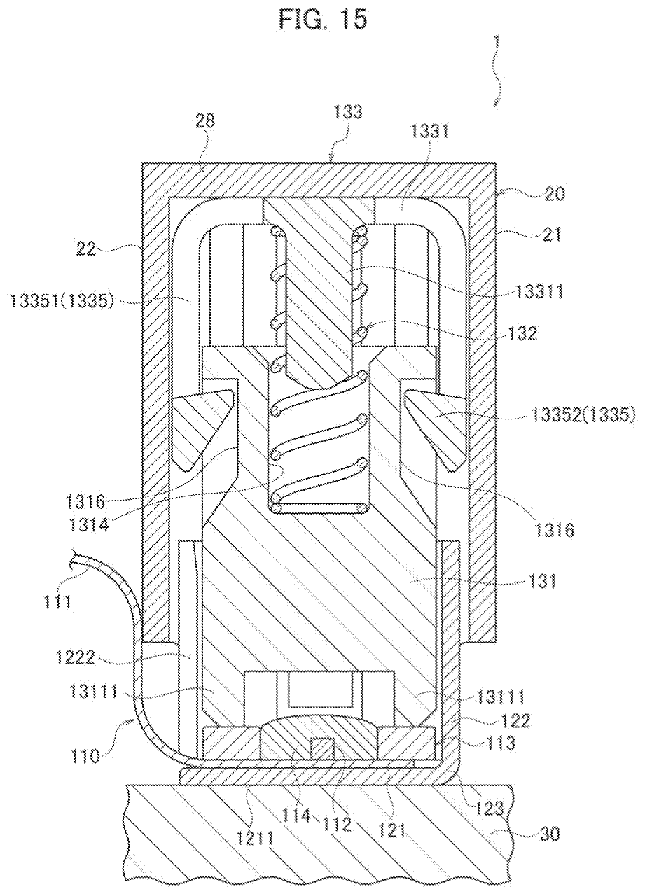

In the present embodiment, as illustrated in FIG. 15, the spring presser 133 includes a locking part 1335 that is locked by the pressing part 131. Specifically, the locking part 1335 includes a pair of arm parts 13351 that extend in the up-down direction and is elastically deformable in the front-rear direction, and hooks 13352 that are provided at the tips of the pair of arm parts 13351, respectively, and are locked by locking recess parts 1316 of the pressing part 131.

The hooks 13352 are locked by the locking recess parts 1316 with the spring 132 arranged between the spring presser 133 and the pressing part 131. In this way, the spring presser 133 is locked by the pressing part 131, and thus the biasing member module 1300 is formed. Note that the spring presser 133 is locked by the pressing part 131 in a state where the movement thereof in the up-down direction is allowed with respect to the pressing part 131.

Also in the present embodiment, as in the above-described fifth embodiment, the pair of hooks 13352 are formed to project inward in the width direction. Thus, even when a large load is applied to the biasing member 130, it is possible to prevent the spring presser 133 from coming off the pressing part 131.

The biasing member module 1300 is configured to be held by the holding member 20 in a state where the movement of the spring presser 133 to the other side (upper side in the up-down direction) in the pressing direction is regulated.

In the present embodiment, the biasing member module 1300 is inserted from below into the holding member 20, and locking parts 1317 formed in the pressing part 131 are locked by lock-receiving parts 27 formed in the holding member 20, so that the biasing member module 1300 is held by the holding member 20. Specifically, the locking parts 1317 include a pair of arm parts 13171 that extend in the up-down direction and is elastically deformable in the front-rear direction, and the hooks 13172 provided at the tips of the pair of arm parts 13171, respectively. The hooks 13172 are hooked on the lock-receiving parts 27, and thus the biasing member module 1300 is held by the holding member 20.

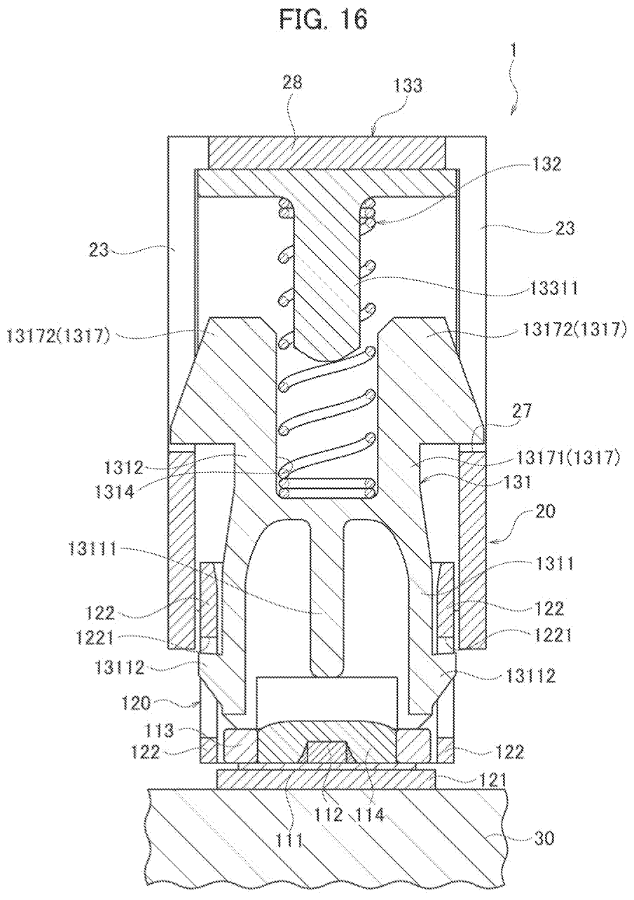

At this time, as illustrated in FIG. 16, the spring presser 133 abuts on a top wall 28 of the holding member 20. In this way, the biasing member module 1300 is held by the holding member 20 in a state where the movement of the spring presser 133 to the other side (the upper side in the up-down direction) in the pressing direction is regulated.

Note that the installation of the biasing member module 1300 to the holding member 20 may be performed after the temperature sensor module 110 is installed in the biasing member module 1300 or before the temperature sensor module 110 is installed in the biasing member module 1300.

With such a configuration, it is also possible to achieve the same actions and effects as with the temperature sensor 10 illustrated in the above-described first to sixth embodiments and its modified examples.

With the configuration illustrated in the present embodiment, when the biasing member module 1300 is held by the holding member 20, it becomes possible to more reliably prevent the spring presser 133 from coming off the pressing part 131. As a result, it becomes possible to more reliably bring the temperature sensor 10 into contact with the cell 30, and it becomes possible to more reliably prevent the temperature measurement performance of the cell 30 from being degraded.

Note that the biasing member module 1300 may be held by the holding member 20 when the biasing member module 1300 is inserted from below into the holding member 20 and the locking parts formed in the spring presser 133 are locked by the lock-receiving parts formed in the holding member 20.

### Seventh Embodiment

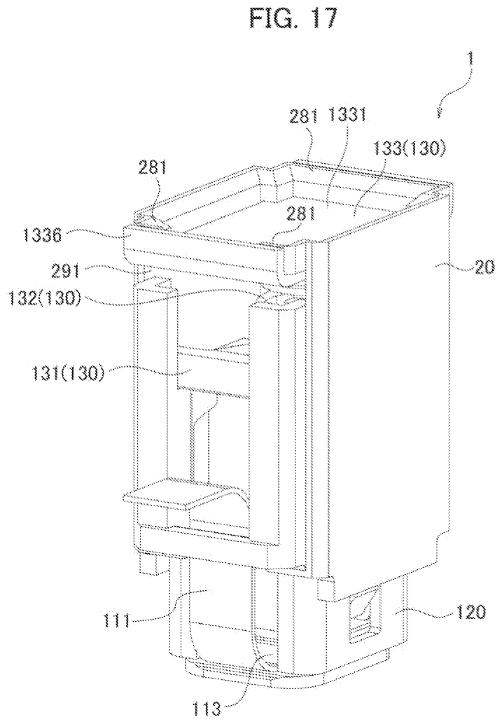

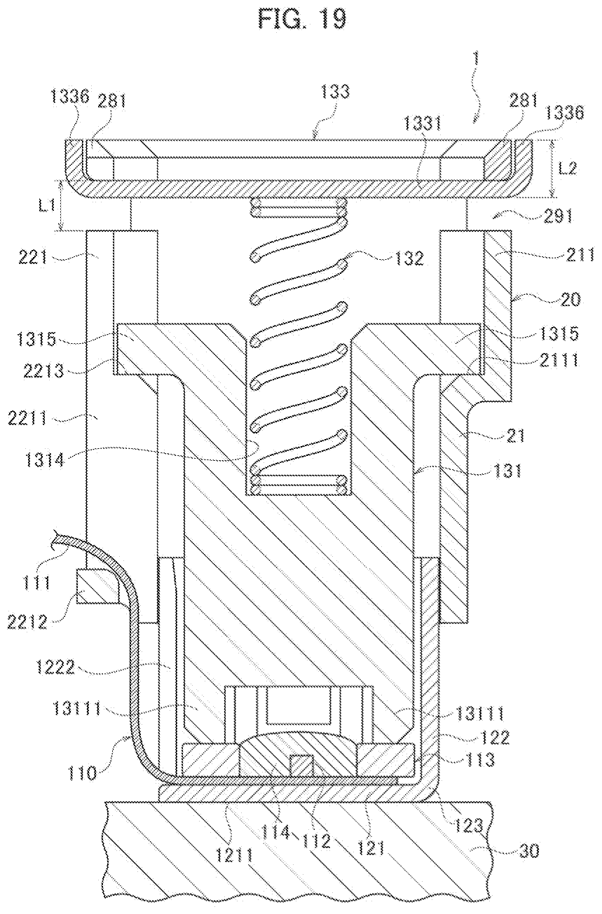

Next, the mounting structure 1 of the temperature sensor 10 according to a seventh embodiment will be described with reference to FIGS. 17 to 19.

The mounting structure 1 of the temperature sensor 10 according to the present embodiment also has basically the same structure as the mounting structure 1 of the 30 temperature sensor 10 illustrated in the above-described second embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

Here, in the present embodiment, the temperature sensor 10 is held by the holding member 20 when the spring presser 133 is slid (moved) relative to the holding member 20 in the intersecting direction (horizontal direction) intersecting the pressing direction. That is, in the present embodiment, the spring presser 133 is configured to be moved relative to the holding member 20 in the intersecting direction (horizontal direction) intersecting the pressing direction.

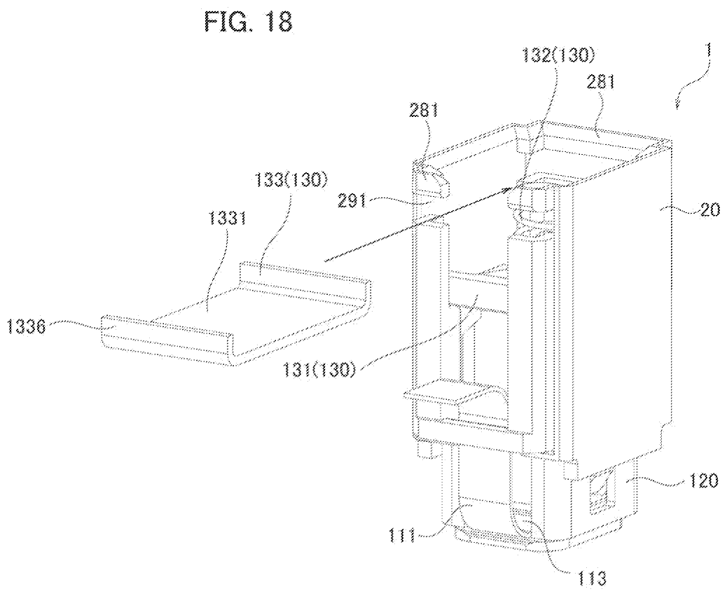

Specifically, as illustrated in FIG. 18, a groove 291 that opens in the horizontal direction is formed in the upper part of the holding member 20, and the temperature sensor 10 is held by the holding member 20 when the spring presser 133 is slid and inserted into the groove 291.

In a state where the spring presser 133 is moved in a relative manner in the intersecting direction (horizontal direction) so as to be in a predetermined position with respect to the holding member 20, the spring presser 133 is pressed by the spring 132 to the other side (upper side in the up-down direction) in the pressing direction.

In the present embodiment, the spring presser 133 includes a pair of regulating walls 1336 connected upward from both ends in the sliding direction of a top wall 1331. The spring presser 133 is capable of being slid in a relative manner in the intersecting direction (horizontal direction) until the pair of regulating walls 1336 are positioned outside the holding member 20. Specifically, a length L1 in the height direction of the groove 291 is larger than a length L2 from the lower surface of the top wall 1331 to the upper end surfaces of the regulating walls 1336. This makes it possible to prevent the regulating walls 1336 from interfering with the holding member 20 when the spring presser 133 is inserted into the groove 291.

With the pair of regulating walls 1336 positioned outside the holding member the spring presser 133 is moved upward by the spring 132. In this way, the pair of regulating walls 1336 come to face an upper wall 281 of the holding member 20, and thus the spring presser 133 is held by the holding member 20 in a state where the movement of the spring presser 133 in the intersecting direction (horizontal direction) is regulated.

Thus, in the present embodiment, the state where the spring presser 133 is slid in the intersecting direction until the pair of regulating walls 1336 are positioned outside the holding member 20 is the predetermined position of the spring presser 133 with respect to the holding member 20.

Note that the members of the temperature sensor 10 other than the spring presser 133 are assembled by inserting them into the holding member 20 in the order from the top, as in the above-described first to sixth embodiments and its modified examples.

With such a configuration, it is also possible to achieve the same actions and effects as with the temperature sensor 10 illustrated in the above-described first to sixth embodiments and its modified examples.

With the configuration illustrated in the present embodiment, it becomes possible to more reliably prevent the spring presser 133 from coming off the holding member 20 without having the hooks 1333 to be locked by the holding member 20. As a result, it becomes possible to simplify the configuration of the temperature sensor 10.

With the configuration where the spring presser 133 is slid in the intersecting direction (horizontal direction), it becomes possible to more easily place the spring presser 133 in the predetermined position with respect to the holding member 20.

### Eighth Embodiment

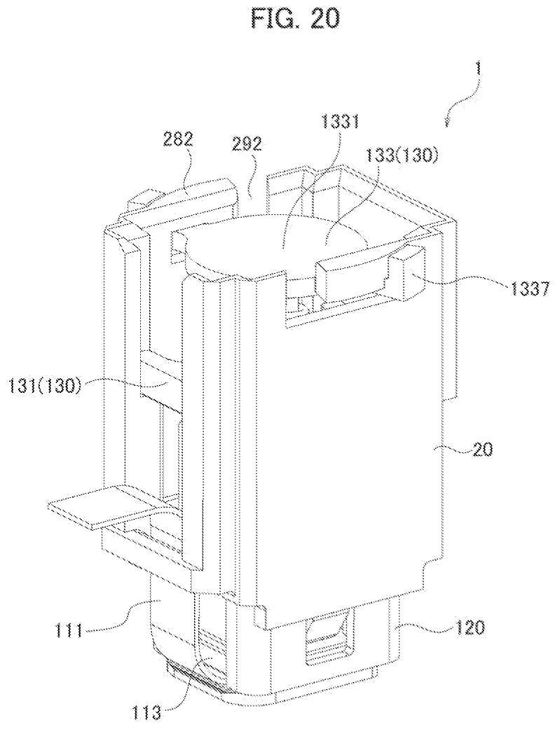

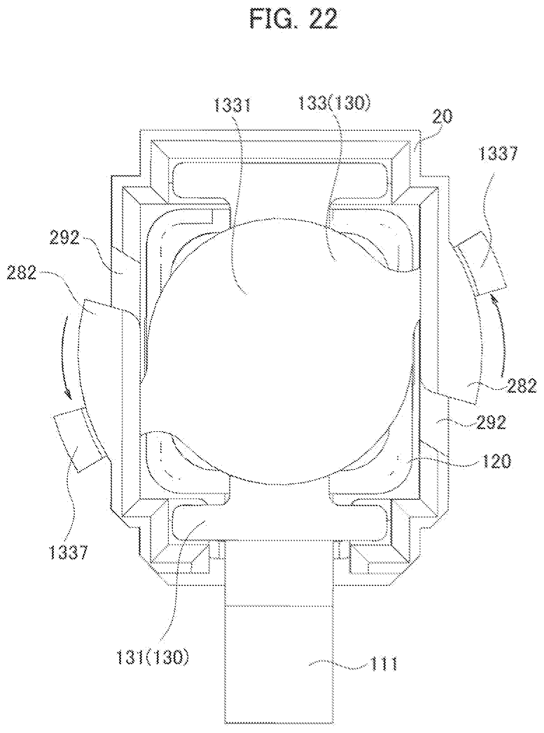

Next, the mounting structure 1 of the temperature sensor 10 according to an eighth embodiment will be described with reference to FIGS. 20 to 22.

The mounting structure 1 of the temperature sensor 10 according to the present embodiment has basically the same structure as the mounting structure 1 of the temperature sensor 10 illustrated in the above-described second embodiment. That is, the mounting structure 1 of the temperature sensor 10 according to the present embodiment is also formed by the temperature sensor 10 held by the holding member 20 in a state where the upward movement of the temperature sensor 10 in the up-down direction is regulated.

Here, in the present embodiment, the temperature sensor 10 is held by the holding member 20 when the spring presser 133 is rotated (moved) relative to the holding member 20 in the intersecting direction (horizontal direction) intersecting the pressing direction. That is, in the present embodiment, the spring presser 133 is possible to move relative to the holding member 20 in the intersecting direction (horizontal direction) intersecting the pressing direction.

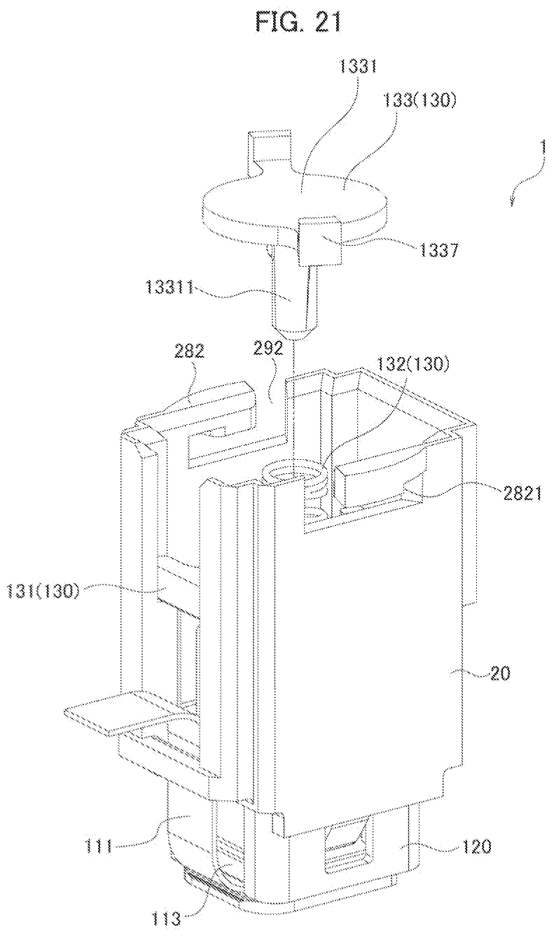

Specifically, as illustrated in FIG. 21, a groove 292 that has an approximate L-shape and opens upward is formed in the upper part of a holding member 20. Meanwhile, in the spring presser 133, a top wall 1331 is formed in an approximately disk shape, and a pair of projecting walls 1337 are formed on the outer peripheral side of the top wall 1331 to project radially outward. In addition, a holding shaft part 13311 is formed to extend downward at the center of the top wall 1331.

Through performing the following operations, the temperature sensor 10 is held by the holding member 20.

First, while the holding shaft part 13311 is inserted into the spring 132 from above, the projecting walls 1337 are inserted into a groove 292 through an opening of the groove 292. Then, the spring presser 133 is pressed downward to move the projecting walls 1337 to the lower parts (the parts extending in the horizontal direction) of the groove 292. Then, the spring presser 133 is turned around the holding shaft part 13311 extending in the pressing direction (the up-down direction), so that the spring presser 133 is in a predetermined position with respect to the holding member 20.

In the present embodiment, the spring presser 133 is rotated to the innermost part of the groove 292 in the horizontal direction. Thus, in the present embodiment, the state where the spring presser 133 is rotated to the innermost part of the groove 292 in the horizontal direction is the predetermined position of the spring presser 133 with respect to the holding member 20.

Then, in a state where the spring presser 133 is relatively rotated (moved) in the intersecting direction (horizontal direction) so as to be in the predetermined position with respect to the holding member 20, the spring presser 133 is moved by the spring 132 to the other side (upper side in the up-down direction) in the pressing direction. Then, the projecting walls 1337 are inserted into notches 2821 formed in the upper walls 282 of the holding member 20. In this way, the spring presser 133 is held by the holding member 20 in a state where the movement of the spring presser 133 in the intersecting direction (horizontal direction) is regulated.

Note that in the present embodiment, members of the temperature sensor 10 including the spring presser 133 are assembled by being inserted into the holding member 20 in the order from the top as in the above-described first to sixth embodiments and its modified examples.

With the configuration illustrated in the present embodiment, it becomes possible to more reliably prevent the spring presser 133 from coming off the holding member 20 without having the hooks 1333 to be locked by the holding member 20. As a result, it becomes possible to simplify the configuration of the temperature sensor 10.

With the configuration where the spring presser 133 is rotated in the intersecting direction (horizontal direction), it becomes possible to more easily place the spring presser 133 in the predetermined position with respect to the holding member 20.

With the configuration where the spring presser 133 is rotated in the intersecting direction (horizontal direction), it becomes possible to prevent the spring 132 from displacing in the horizontal direction when the spring presser 133 is moved in a relative manner.

### Actions and Effects

The following describes the characteristic configuration of the temperature sensor illustrated in each of the above embodiments and its modified examples, and the effects obtained through the configuration.

The temperature sensor 10 illustrated in each of the above-described embodiments and its modified examples includes the sensor chip (sensor part) 112 provided on the flexible thin-plate wire 111 to detect the temperature of the cell (part to be measured) 30. The temperature sensor 10 also includes the biasing member 130 capable of pressing the sensor chip 112. In addition, the biasing member 130 includes the pressing part 131 that presses the sensor chip 112 toward the cell 30. The biasing member 130 includes the spring (biasing part) 132 that applies to the pressing part 131 a biasing force toward one side (lower side in the up-down direction) in the pressing direction in which the sensor chip 112 is pressed toward the cell 30. Furthermore, the biasing member 130 includes the spring presser (part to be held) 133 that is held by the holding member in a state where movement of the spring presser 133 to the other side (upper side in the up-down direction) in the pressing direction is regulated.

In addition, the spring presser 133 includes the locking pieces 1332 that are elastically deformable in the intersecting direction (horizontal direction) intersecting the pressing direction. Furthermore, the spring presser 133 includes the hooks (locking parts) 1333 that are provided on the locking pieces 1332 and are to be locked by the holding member 20 in a state where the movement to the other side (upper side in the up-down direction) in the pressing direction is regulated.

The biasing member 130 includes the regulating part that regulates the movement of the locking pieces 1332 in the intersecting direction (horizontal direction) and prevents release of the locking between the hooks 1333 and the holding member 20.

In this way, even when the cell 30 moves to the other side in the pressing direction (the upper side in the up-down direction) and a large load is applied to the biasing member 130, it becomes possible to prevent release of the locking between the hooks 1333 and the holding member 20. As a result, it becomes possible to more reliably bring the temperature sensor 10 into contact with the cell 30, and it becomes possible to more reliably prevent the temperature measurement performance of the cell 30 from being degraded.

In addition, the regulating part may include the wide part (pressing part-side regulating wall) 1311 which is provided in the pressing part 131 and with which the locking pieces 1332 can be brought into contact before the locking between the hooks 1333 and the holding member 20 is released.

In this way, it becomes possible to prevent release of the locking between the hooks 1333 and the holding member 20 while the configuration is simplified. Furthermore, even in the case where the hooks 1333 are configured to be locked by the holding member 20 without having the hooks 1333 projecting outside the holding member 20, it becomes possible to prevent release of the locking between the hooks 1333 and the holding member.

In addition, the regulating part may include the locking part-side regulating walls 13331 that are provided on the hooks 1333 and are to face the holding member 20 in the intersecting direction (horizontal direction).

This enables to have a configuration to hold the holding member 20 between the locking pieces 1332 and the locking part-side regulating walls 13331, and it becomes possible to prevent release of the locking between the hooks 1333 and the holding member 20. It is possible to prevent release of the locking between the hooks 1333 and the holding member 20, only by holding of the holding member 20 between the locking pieces 1332 and the locking part-side regulating walls 13331, so that it becomes possible to simplify the configuration.

The biasing member 130 may also include the biasing member module 1300. The biasing member module 1300 may include the pressing part 131 that presses the sensor chip 112 toward the cell 30. The biasing member module 1300 may include the spring 132 that applies to the pressing part 131 a biasing force toward one side (the lower side in the up-down direction) in the pressing direction in which the sensor chip 112 is pressed toward the cell 30. Furthermore, the biasing member module 1300 may include the spring presser 133 that engages with the pressing part 131 while having the spring 132 positioned therebetween. The biasing member module 1300 may be configured to be held by the holding member 20 in a state where the movement of the spring presser 133 to the other side (the upper side in the up-down direction) in the pressing direction is regulated.

Thus, when the biasing member module 1300 is held by the holding member 20, it becomes possible to more reliably prevent the spring presser 133 from coming off the pressing part 131. As a result, it becomes possible to more reliably bring the temperature sensor 10 into contact with the cell 30, and it becomes possible to more reliably prevent the temperature measurement performance of the cell 30 from being degraded.

The spring presser 133 may be configured to be moved relative to the holding member 20 in the intersecting direction (horizontal direction) intersecting the pressing direction. In a state where the spring presser 133 is relatively moved in the intersecting direction (horizontal direction) so as to be in the predetermined position with respect to the holding member 20, the spring presser 133 may be pressed by the spring 132 to the other side (upper side in the up-down direction) in the pressing direction. In this way, the spring presser 133 may be held by the holding member 20 in a state where the movement of the spring presser 133 in the intersecting direction horizontal direction is regulated.

In this way, it becomes possible to more reliably prevent the spring presser 133 from coming off the holding member 20 without having the hooks 1333 to be locked by the holding member 20. As a result, it becomes possible to simplify the configuration of the temperature sensor 10.

### [Others]

Although embodiments have been described above, the present disclosure is not limited to these, and various modifications are possible within the scope of the gist of the present disclosure.

For example, it is possible to make a temperature sensor by suitably combining the configurations illustrated in each of the above-described embodiments and their modified examples.

In each of the above-described embodiments and their modified examples, the sensor chip 112 having an approximately rectangular parallelepiped shape is exemplified, but the shape of the sensor chip 112 is not limited to such a shape, and it is possible to have various shapes, such as an approximately cylindrical shape.

In each of the above-described embodiments and their modified examples, the case 120 having a box shape of an approximately rectangular parallelepiped is exemplified, but the shape of the case 120 is not limited to such a shape, and it is possible to have various shapes, such as a box shape of an approximate cylinder.

In each of the above-described embodiments and their modified examples, the frame-shaped member 113 having an approximately quadrilateral contour shape is exemplified, but the contour shape of the frame-shaped member 113 is not limited to such a shape, and it is possible to have various shapes, such as an approximately circular contour shape.

In each of the above-described embodiments and their modified examples, the spring is exemplified as the biasing part, but it is also possible to form the biasing part with an elastic body, such as rubber.

Also, the specifications of the sensor part, the biasing member, and other details (shape, size, layout, and the like) are changeable as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A temperature sensor comprising:
a sensor part that is provided on a flexible thin-plate wire and detects a temperature of a part to be measured; and
a biasing member that is capable of pressing the sensor part, wherein
the biasing member includes:
a pressing part that presses the sensor part toward the part to be measured;
a biasing part that applies to the pressing part a biasing force toward one side in a pressing direction in which the sensor part is pressed toward the part to be measured; and
a part to be held that is to be held by a holding member in a state where movement of the part to be held to the other side in the pressing direction is regulated,
the part to be held includes a locking piece that is elastically deformable in an intersecting direction intersecting with the pressing direction, and a locking part that is provided on the locking piece and is to be locked by the holding member in a state where movement of the locking part to the other side in the pressing direction is regulated, and
the biasing member includes a regulating part that regulates movement of the locking piece in the intersecting direction and prevents release of locking between the locking part and the holding member.

2. The temperature sensor according to claim 1, wherein
the regulating part includes a pressing part-side regulating wall which is provided in the pressing part and with which the locking piece can be brought into contact before the locking between the locking part and the holding member is released.

3. The temperature sensor according to claim 1, wherein
the regulating part includes a locking part-side regulating wall that is included in the locking part and is to face the holding member in the intersecting direction.

4. A temperature sensor comprising:
a sensor part that is provided on a flexible thin-plate wire and detects a temperature of a part to be measured; and
a biasing member that is capable of pressing the sensor part, wherein
the biasing member includes a biasing member module including:
a pressing part that presses the sensor part toward the part to be measured;
a biasing part that applies to the pressing part a biasing force toward one side in a pressing direction in which the sensor part is pressed toward the part to be measured; and
a part to be held that engages with the pressing part in a state where the biasing part is placed therebetween, and
the biasing member module is configured to be held by a holding member in a state where movement of the part to be held to the other side in the pressing direction is regulated.

5. A temperature sensor comprising:
a sensor part that is provided on a flexible thin-plate wire and detects a temperature of a part to be measured; and
a biasing member that is capable of pressing the sensor part, wherein
the biasing member includes:
a pressing part that presses the sensor part toward the part to be measured;
a biasing part that applies to the pressing part a biasing force toward one side in a pressing direction in which the sensor part is pressed toward the part to be measured; and
a part to be held that is to be held by a holding member in a state where movement of the part to be held to the other side in the pressing direction is regulated,
the part to be held is configured to be capable of being moved relative to the holding member in an intersecting direction intersecting with the pressing direction, and
in a state where the part to be held has been moved in a relative manner in the intersecting direction to be positioned in a predetermined position with respect to the holding member, when the part to be held is pressed by the biasing part toward the other side in the pressing direction, the part to be held is held by the holding member in a state where movement of the part to be held in the intersecting direction is regulated.
